(19) United States
(12) Patent Application Publication
(10) Pub. No.: US 2022/0225164 A1
(43) Pub. Date: Jul. 14, 2022

(54) METHOD FOR ADDRESSING A TERMINAL

(71) Applicant: Diehl Metering Systems GmbH, Nuernberg (DE)

(72) Inventors: Stefan Schmitz, Nuernberg (DE); Thomas Blank, Merkendorf (DE)

(21) Appl. No.: 17/709,955

(22) Filed: Mar. 31, 2022

Related U.S. Application Data
(63) Continuation of application No. PCT/EP2020/076729, filed on Sep. 24, 2020.

(30) Foreign Application Priority Data
Oct. 2, 2019 (DE) 10 2019 006 877.7

(51) Int. Cl. H04W 28/06; H04W 28/02; H04L 69/22

(52) U.S. Cl. CPC H04W 28/06; H04W 88/16; H04L 69/22; H04W 28/0215

(57) ABSTRACT

A method for addressing a terminal, preferably a meter, of a group of terminals, includes providing a primary wireless communication channel between a gateway and the respective terminal, assigned to the gateway, of a wireless communication system, preferably a wireless MBus communication system. In order to improve the primary communication, the gateway is assigned a sub-network which is formed of the gateway in question and at least one terminal, preferably a group of terminals. A terminal network address is generated for each terminal assigned to the gateway of the sub-network, and the terminal network address is used to transfer data in the primary communication channel between the gateway and terminals assigned to the gateway.

### CROSS-REFERENCE TO RELATED APPLICATION

This application is a continuation, under 35 U.S.C. § 120, of copending International Patent Application PCT/EP2020/076729, filed Sep. 24, 2020, which designated the United States; this application also claims the priority, under 35 U.S.C. § 119, of German Patent Application DE 10 2019 006 877.7, filed Oct. 2, 2019; the prior applications are herewith incorporated by reference in their entirety.

### FIELD AND BACKGROUND OF THE INVENTION

The invention relates to a method for addressing a terminal, for example a consumption meter, of a group of terminals, in a primary communication channel between a gateway and a terminal, assigned to the gateway, of a wireless communication system, preferably a wireless MBus communication system.

Communication systems already exist in which data, preferably consumption data of in particular long-term energy-independent terminal devices (Smart Metering devices) can be transmitted wirelessly to gateways using specific communication protocols. The gateways then forward the data to data centers (headend) in different ways. The data are then evaluated in the data centers. That involves in particular data relating to the consumption of water, heat, gas or electricity. The communication channel between the terminals and a gateway is designated the primary communication channel, and the communication channel between a gateway and the data center is called the tertiary communication channel. A communication channel between two gateways is called the secondary communication channel. The present invention is concerned with the format of the communication in the primary wireless communication channel. Such a communication system is, for example, the so-called OMS (Open Metering System). With OMS, all devices, including those from different manufacturers, communicate by using the same communication protocol. For that purpose, a specific worldwide unique digital address is provided, which must therefore necessarily have a certain length. The technical platform of the OMS is the so-called MBus. Wireless MBus communication is regulated in particular in the EN13757 standard.

The data is provided by the terminals to the respective gateway in the form of data messages. For transmission, the data messages in the respective terminal can be divided into individual data packets and transmitted through the primary communication channel. In the gateway, the individual data packets are recombined to produce the data message. As an alternative, data telegrams can also be transmitted as complete units. The primary communication channel is a narrow-band channel. The data packets or data messages of the individual terminals must be transmitted through that channel with as little distortion as possible. In addition, efforts are made to combine as many terminals as possible under one gateway, which in turn has a negative impact on transmission. It is therefore difficult to implement those conflicting objectives.

### SUMMARY OF THE INVENTION

It is accordingly an object of the invention to provide a method for addressing a terminal, which overcomes the hereinafore-mentioned disadvantages of the heretofore-known methods of this general type and which further improves the transmission of data from a terminal to a base station in the primary communication channel.

With the foregoing and other objects in view there is provided, in accordance with the invention, a method for addressing a terminal, preferably a consumption meter, of a group of terminals, wherein a primary wireless communication channel is provided between a gateway and the respective terminal, assigned to the gateway, of a wireless communication system, preferably a wireless MBus communication system, each gateway of the wireless communication system with primary and tertiary communication, preferably of a corresponding wireless MBus communication system, is assigned a sub-network which is formed from the relevant gateway and at least one terminal, preferably a group of terminals, a terminal network address is generated for each terminal assigned to the gateway of the sub-network, and the terminal network address is used to transmit data in the primary communication channel between the gateway and the terminals assigned to the latter.

Advantageous embodiments of the method according to the invention are specified in the dependent claims.

This terminal network address can be implemented in the communication protocol in a much shorter form than the “actual address” of the terminal and according to the invention is configured to transmit data in the primary communication channel between the gateway and the terminals assigned thereto. This can effectively reduce the overall length of the primary communication messages. Nevertheless, the respective terminal can be uniquely identified in the overall system. Due to the reduced length of the primary communication messages, the channel assignment can be reduced compared to previous implementations. In addition, the range or reception probability can be increased, as the influence of interferers decreases.

The terminal network address generated by the gateway is used in continuous operation instead of a standardized address of the wireless communication system or the corresponding communication protocol. The standardized (unique) address of the respective terminal device, e.g. the MBus address, therefore only needs to be used during the initialization of the entire system. During operation, the terminal network address is used instead.

The terminal network address contains a smaller number of bytes than the standardized address of the wireless communication system or the corresponding communication protocol designated for a terminal device.

The terminal network address is preferably shorter than 8 bytes, i.e. shorter than the standardized address of the MBus communication protocol, which is 8 bytes long.

The respective terminal network address includes a primary sub-network address and a meter address.

The primary sub-network address is preferably 1 byte long, and the meter address is preferably 2 bytes long. Accordingly, the length of the terminal network address is less than half the length of the aforementioned MBus address.

The respective terminal network address of each terminal preferably includes a gateway address.

The respective terminal network address of each terminal is advantageously a primary network address, which is formed by a primary sub-network address and a meter address.

In particular, the terminal network address or meter address is only assigned once within a sub-network of a gateway.

Advantageously, the terminal network address is generated by the gateway. This can preferably be carried out when the gateway is first paired with the terminal concerned.

According to the method of the invention, a tertiary communication channel is provided between the gateway and a headend or data center, wherein in the headend the data transmitted to the headend through the tertiary communication channel is assigned on the basis of the terminal network address. The headend, i.e. the overall system, is thus able to perform an assignment based on the terminal network address.

Preferably, a unique assignment (correlation) can be performed in the headend based on a combination of the gateway address and the primary network address.

Alternatively or in addition, an assignment (correlation) can also take place in the gateway. If the gateway knows its primary sub-network address, it can independently assign primary network addresses to terminals and correlate them.

The terminal network address can preferably be used in the primary communication channel and preferably also in the tertiary communication channel in both directions, i.e. in the uplink and downlink.

Other features which are considered as characteristic for the invention are set forth in the appended claims.

Although the invention is illustrated and described herein as embodied in a method for addressing a terminal, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a greatly simplified block diagram of an example of the addressing concept according to the present invention;

FIG. 2 is a diagram showing an example of a terminal network address as it is used in the method according to the invention; and

FIG. 3 is a greatly simplified block diagram of another example of the addressing concept according to the present invention, in which a terminal of a sub-network is within the range of a gateway of another sub-network.

### DETAILED DESCRIPTION OF THE INVENTION

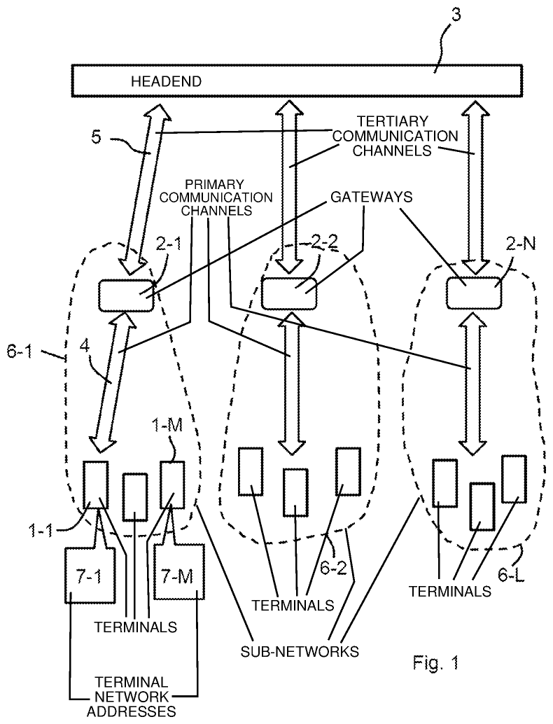

Referring now to the figures of the drawings in detail and first, particularly, to FIG. 1 thereof, there is seen a communication structure of a generic wireless communication system for wireless communication between terminals 1-1, 1-M, e.g. permanently installed consumption meters for water, heat, gas or electricity, which communicate with a headend 3 through a wireless communication system, in particular a wireless MBus communication system, through gateways 2-1, 2-N. The wireless communication channel between the respective terminal, e.g. 1-1, and the associated gateway, e.g. 2-1, is called the primary communication channel 4. The communication channel between the respective gateway, e.g. 2-1, and the headend 3 is called the tertiary communication channel 5.

The respective data is provided in the form of data messages in the terminals 1-1, 1-M and is divided into individual data packets for transmission along the primary communication channel 4. After receipt, the data packets are recombined in the gateway to produce the data message. Alternatively, the data messages can also be transferred as they are, i.e. completely, to the gateway. The primary communication channel 4 is usually a narrow-band radio channel.

The data can be transmitted onward from the respective gateway 2-1, 2-N, through a WAN (e.g. the internet) to the headend 3. For example, the headend 3 is operated by a supplier of water, heat, gas and/or electricity.

A downlink transmission of data from the headend 3 to the respective gateway 2-1, 2-N as well as on to the respective terminal 1-1, 1-M can also take place, for example, for the transmission of certain commands or in the case of required software updates.

Within the overall system, each gateway 2-1, 2-N has its own address (e.g. MAC address) and each terminal 1-1, 1-M also has a unique, manufacturer-independent address in the communication system. For example, in OMS a terminal 1-1, 1-M has an 8-byte address, due to the so-called M-field (2 bytes) and A-field (6 bytes) (EN13757-4). This address is unique worldwide.

The respective terminal 1-1, 1-M retains this (unique) address thereafter. However, in the method according to the invention, a further “shorter” address is also assigned, which is then used in the primary communication, i.e. in continuous operation, between the relevant gateway, e.g. 2-1, and the associated terminals 1-1, 1-M, preferably in both directions. This is a terminal network address 7-1, 7-M, which is assigned for each terminal 1-1, 1-M within a sub-network 6-1, 6-L of the associated gateway 2-1, 2-N. The terminal network address 7-1, 7-M is assigned by the gateway, for example 2-1, of the relevant sub-network, for example 6-1, when pairing the relevant terminal, for example 7-1, with the gateway, for example 2-1.

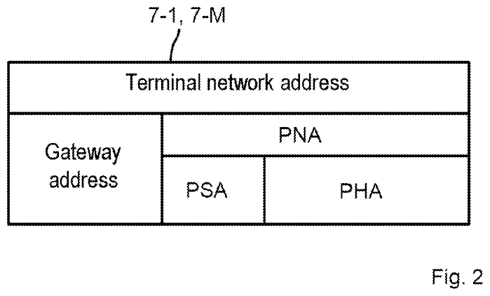

FIG. 2 shows how the terminal network address 7-1, 7-M is structured. It includes a primary sub-network address PSA, which identifies the respective sub-network 6-1, 6-L. For example, the primary sub-network address PSA is 1 byte long. Furthermore, the terminal network address 7-1, 7-M includes a primary host address PHA which identifies the relevant terminal 1-1, 1-M within the sub-network and preferably has a length of 2 bytes. Within the respective sub-network 6-1, 6-L, the primary host address PHA may only be assigned once. The primary sub-network address PSA and the primary host address jointly form the primary network address PNA, which is therefore only 3 bytes long, for example, i.e. much shorter than the 8-byte (unique) address of the terminal in the standard.

The gateway address uniquely identifies a specific gateway 2-1, 2-N in the overall system. For example, a MAC address can be used as the gateway address. A combination of gateway address and terminal network address 7-1, 7-M or primary network address PNA thus uniquely identifies a terminal in the overall system (primary and tertiary communication).

Each gateway 2-1, 2-N is thus assigned the respective sub-network 6-1, 6-L through the primary sub-network address PSA. The primary sub-network address PSA does not need to be unique. However, it should be ensured that the sub-networks are located physically far enough apart from each other that a meter cannot be located in two sub-networks. The address range offers 255 possible sub-networks, which is more than sufficient for all known fixed networks.

Each terminal 7-1, 7-M is thus assigned to a gateway, e.g. 2-1, and thus to a fixed network, e.g. 6-1. When the gateway 2-1 is first paired with the meter 7-1, the gateway assigns the primary host address PHA for the relevant terminal. Together with the primary sub-network address PSA, the primary network address PNA is formed and assigned to the meter, e.g. 7-1, as a short address. Mapping from the wireless MBus to PNA in the gateway is possible at any time.

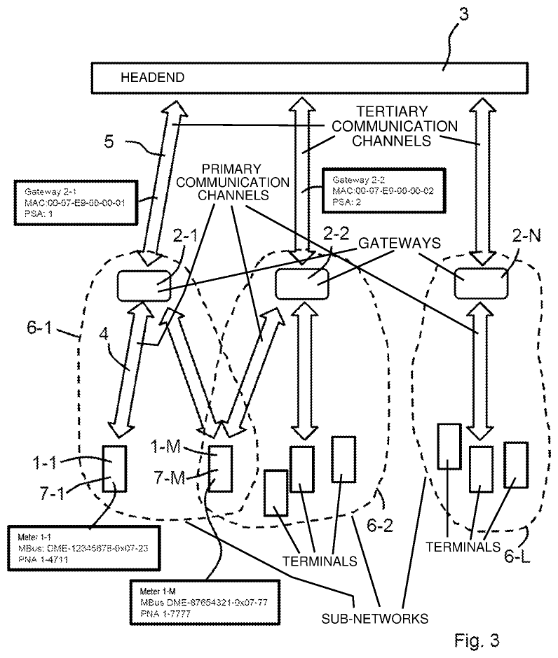

In the example shown in FIG. 3, the meter 7-M is accessible not only from the gateway 2-1 but also from the gateway 2-2. The gateway 2-2 forwards the data received from the meter 7-M to the headend 3 in the uplink. On the basis of the known network structure, the headend 3 can correlate the primary network address PNA with the standardized (i.e. unique) meter address of the communication protocol (e.g. MBus address with a length of 8 bytes).

In the example shown in FIG. 3, the meter 7-M is within range of gateway 2-1 and gateway 2-2. However, the terminal 7-M is assigned to the gateway 2-1 and from this it has the primary sub-network address PSA=1 (sub-network 6-1) and the primary host address PHA=7777 (terminal 7-M). The primary network address PNA is therefore 1-7777. The gateway 2-1 can uniquely identify the meter 7-M at any time using the pairing. The gateway 2-2 has no knowledge of the pairing of the terminal 7-M with the gateway 2-1. However, the gateway 2-2 uses the primary sub-network address PSA to detect that the terminal 7-M is in a different sub-network (sub-network 6-1) than the sub-network 6-2. If the gateway 2-2 forwards the data or messages from the terminal 7-M to the headend 3, the headend 3 detects that the primary sub-network address PSA and the gateway address do not match. Using the network structure, the primary sub-network address PSA can then be correlated with the gateway 2-1.

Alternatively or in addition, an assignment (correlation) can also take place in the gateway 2-1, 2-N. If the gateway 2-1, 2-N knows its primary sub-network address PSA, it can independently assign primary network addresses PNA to terminals 1-1, 1-M and correlate them.

The following is a summary list of reference numerals and the corresponding structure used in the above description of the invention.

### LIST OF REFERENCE SIGNS

1-1, 1-M terminal
2-1, 2-N gateway
headend
primary communication channel
tertiary communication channel
6-1, 6-L sub-network
7-1, 7-M terminal network address
PHA primary host address
PNA primary network address
PSA primary sub-network address

1. A method for addressing a terminal, or a consumption meter, of a group of terminals, the method comprising:
providing a primary wireless communication channel between a gateway and a respective terminal, assigned to the gateway, of a wireless communication system or a wireless MBus communication system;
assigning to the gateway a sub-network formed by the gateway and at least one terminal or a group of terminals;
generating a terminal network address for each terminal assigned to the gateway of the sub-network; and
using the terminal network address to transmit data in the primary communication channel between the gateway and the terminal devices assigned to the gateway.

2. The method according to claim 1, which further comprises, in continuous operation, using the terminal network address instead of a standardized address of the wireless communication system.

3. The method according to claim 1, which further comprises providing the terminal network address with a lower number of bytes than a standardized address of the wireless communication system for a terminal.

4. The method according to claim 1, wherein the terminal network address is shorter than 8 bytes.

5. The method according to claim 1, which further comprises providing the respective terminal network address of each terminal with a primary sub-network address and a meter address.

6. The method according to claim 5, which further comprises providing the primary sub-network address with a length of 1 byte.

7. The method according to claim 6, which further comprises providing the meter address with a length of 2 bytes.

8. The method according to claim 1, which further comprises providing the respective terminal network address of each terminal with a gateway address.

9. The method according to claim 5, which further comprises forming a primary network address from the primary sub-network address and the meter address.

10. The method according to claim 9, which further comprises assigning the terminal network address or the meter address or the primary network address only once within a sub-network.

11. The method according to claim 1, which further comprises using the gateway to generate the terminal network address.

12. The method according to claim 1, which further comprises using the gateway to generate the terminal network address when the gateway is paired with the terminal.

13. The method according to claim 1, which further comprises:
providing a tertiary communication channel between the gateway and a headend; and
in the headend, assigning data of the terminals transmitted through the tertiary communication channel to the headend based on the terminal network address.

14. The method according to claim 1, which further comprises, in the gateway, assigning the data received from the gateway based on the terminal network address.

15. The method according to claim 13, which further comprises basing the assignment on a combination of a gateway address and a primary network address or a primary sub-network address.

16. The method according to claim 1, which further comprises using the terminal network address in the primary communication channel in both directions.
